(19) United States
(12) Patent Application Publication
(10) Pub. No.: US 2025/0383487 A1
(43) Pub. Date: Dec. 18, 2025

(54) COATING FOR OPTICAL SURFACES

(71) Applicant: BAE SYSTEMS PLC, London (GB)

(72) Inventors: Jonathan Paul Freeman, Rochester Kent (GB); Paul Stewart Morant, Rochester Kent (GB)

(73) Assignee: BAE SYSTEMS PLC, London (GB)

(21) Appl. No.: 18/998,341

(22) PCT Filed: Jul. 25, 2023
(86) PCT No.: PCT/GB2023/051956

§ 371 Date: Jan. 24, 2025

(30) Foreign Application Priority Data
Jul. 27, 2022 (EP) 22275103.4
Jul. 27, 2022 (GB) 2210948.2

(51) Int. Cl. G02B 5/20; G02B 27/01

(52) U.S. Cl. CPC G02B 5/20; G02B 27/0172; G02B 2027/0112; G02B 2027/012

(57) ABSTRACT

A coating for an optical surface for reducing secondary reflections from narrow wavelength band image sources, the coating comprising multiple notch filters located at different predetermined wavelength regions.

### FIELD

The present invention relates to a coating for optical surfaces, preferably but not exclusively for a helmet visor or the like.

### BACKGROUND

There are many situations in which a user may wear a helmet. For example, a pilot of a plane, a motorbike rider and many other places which may present a hazard to the user. An integral part of the helmet is a visor which provides a view on the surroundings. In some cases, the visor may further provide an augmented or virtual component which allows the user to see other types of information or data.

A problem which exists with visors is that it is notoriously difficult to deposit a good anti-reflective coating on the outside of a visor as might be used in a visor projected display. The visor is typically made from a polycarbonate which is usually hard coated to reduce scratching. The hard coating tends to optically interfere with the performance of any anti-reflection coating deposited on the hard coating, making the anti-reflection coating inefficient and often limiting its performance to no better than 1%. The resultant optical effect is the introduction of secondary reflections from the outside of the visor which can be objectionable and potentially dangerous in visually critical contexts.

In a known visor an incident beam passes from display optics towards the visor. The incident beam is reflected by an inner coating towards the user making an intended primary image. The incident beam is also transmitted through the visor and then reflected by an outer coating of the visor towards the eye. The beam is then transmitted back through the inner coating giving secondary reflection. The nature of the secondary reflection is dependent on many variables but is undesirable.

As a result, there is a need for an improved anti-reflective coating which overcomes at least some of the problems of current visors.

A further object is to implement a visor having a coating in which the secondaries are mitigated or removed.

### SUMMARY

According to an aspect of the present invention, there is provided a coating for an optical surface for reducing secondary reflections from narrow wavelength band image sources, the coating comprising multiple notch filters located at different predetermined wavelength regions.

In an aspect the multiple notch filters comprise three notch filters.

In an aspect the different predetermined wavelength regions comprise red, green and blue wavelength regions.

In an aspect a first notch includes a full-width-half-max of about 50 nm, and a peak reflectivity of about 80%. The first notch full-width-half max may be in the range of 40 to 60 nm, or be in the range of 45 to 55 nm. In addition or alternatively, the peak reflectivity may be in the range of 70 to 90% or in the range of 75 to 85%.

In an aspect a second notch includes a full-width-half-max of about 50 nm, and a peak reflectivity of about 70%. The second notch full-width-half max may be in the range of 40 to 60 nm, or be in the range of 45 to 55 nm. In addition or alternatively, the peak reflectivity may be in the range of 60 to 80% or in the range of 65 to 75%.

In an aspect a third notch has a full-width-half-max of about 50 nm, and a peak reflectivity of about 65%. The second notch full-width-half max may be in the range of 40 to 60 nm, or be in the range of 45 to 55 nm. In addition or alternatively, the peak reflectivity may be in the range of 55 to 75% or in the range of 60 to 70%.

In an aspect a centre of a first notch is approximately 440 nm.

In an aspect a centre of a second notch is approximately 520 nm.

In an aspect a centre of a third notch is approximately 630 nm.

In an aspect the coating further comprises a first dielectric coating under the multiple notch filters.

In an aspect the coating further comprises a second dielectric coating over the multiple notch filters.

In an aspect the second dielectric coating comprises a dip-hard coating,

According to an aspect of the present invention, there is provided a visor having a coating according to another aspect.

In an aspect the visor is made from a polycarbonate material

In an aspect the coating is located on an inner surface of the visor.

In an aspect a further anti-reflective coating is located on an outer surface of the visor.

According to an aspect of the present invention, there is provided a helmet including a visor according to another aspect

According to an aspect of the present invention, there is provided a method of applying a coating, that reduces secondary reflection from narrow wavelength band images sources to an optical surface, the method comprises applying multiple layers of material each having a notch filter located at different predetermined wavelength regions.

In an aspect the method comprises applying three layers of material to form respective notches.

In an aspect further comprising applying the multiple layers in the red, green and blue wavelength regions.

In an aspect further comprising forming a first notch includes a full-width-half-max of about 50 nm, and a peak reflectivity of about 80%.

In an aspect further comprising forming a second notch includes a full-width-half-max of about 50 nm, and a peak reflectivity of about 70%.

In an aspect further comprising forming a third notch has a full-width-half-max of about 50 nm, and a peak reflectivity of about 65%.

In an aspect further comprising forming a centre of a first notch at approximately 440 nm; a centre of a second notch at approximately 520 nm and a centre of a third notch at approximately 630 nm.

According to an aspect of the present invention, there is provided a method of forming a visor comprising applying a coating made by the method according to another aspect to a polycarbonate visor.

### BRIEF DESCRIPTION OF THE FIGURES

Embodiments of the invention will now be described by way of example only with reference to the figures, in which:

FIG. 1 shows a simplified diagram of a helmet including a visor according to the present invention;

FIG. 2 is a simplified view of the visor of FIG. 1;

FIG. 3 is a representation of a spectral profile of a coating for a visor according to the present invention;

FIG. 4 is a graph representing the optical properties achieved using the visor of the present invention; and

FIG. 5 is a flow diagram showing how an anti-reflective coating is produced.

### DETAILED DESCRIPTION

The present invention relates to a visor having an anti-reflective coating which both reduces secondary reflections and further augments the brightness of the image produced by the visor.

The secondary reflections are reduced by making the reflection of the image from the inside of the visor stronger. This gives rise to a visor in which the main image is brighter and less light hits the outer surface so less is reflected back. An issue with this is that if the inside surface has a spectrally broad reflective coating, then in making this more reflective there will be a reduction of light from the outside world transmission. The present invention is to use spectrally narrow band image sources for each of red, green and blue (RGB) wavelengths and to provide a narrow notch filter in the reflection coating on the visor so as to efficiently reflect the RGB image and wide enough to maintain an optimal outside world transmission.

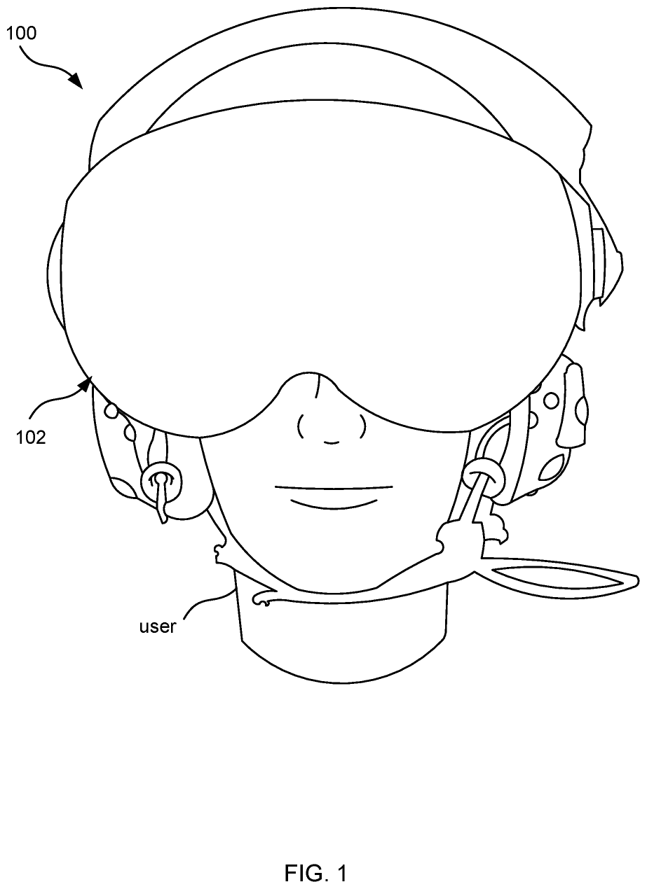

FIG. 1 illustrates a helmet 100 including a visor 102. The helmet is suitable for being worn on the head of a user. In use, the user wears the helmet for head protection and uses the visor to see a real image of the outside world and augmented or virtual images from an imaging system (not shown). The imaging system is able to combine the real world images and the augmented or virtual images.

A typical user is a pilot of a vehicle such as an aircraft or any user who needs head protection using an imaging system.

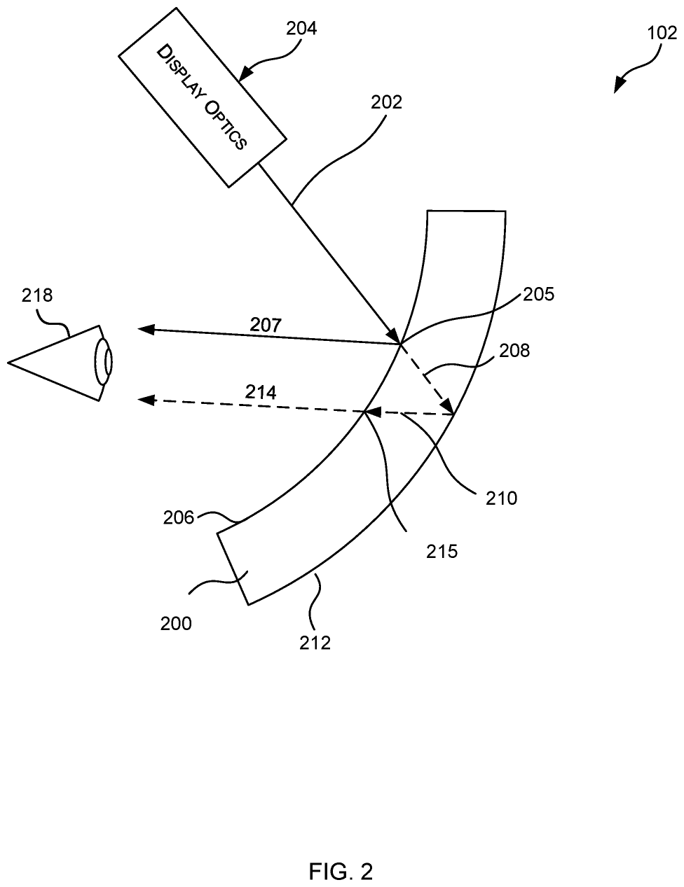

FIG. 2 is a schematic diagram of the visor 102. The visor 102 is a curved element which is supported on the helmet. The visor comprises a polycarbonate combiner 200 and includes an inner coating 206 at inner surface and outer coating 212 at outer surface. The combiner 200 provides images to a user represented as an eye 218 and provides an image of the real world and images from display optics 204 of the imaging system.

The display optics 204 produce an incident beam 202 which is reflected at region 205 by an inner coating 206 towards the user making the intended primary image 207. However, the incident beam 202 is also prone to being transmitted 208 through region 205 and into the combiner 200. The transmitted beam 208 is then reflected 210 by an outer coating 212 towards the eye 218. The reflected beam 210 is then transmitted back through the inner coating 206 at region 215 giving the undesired secondary reflection/image 214.

The display optics 204 provide a virtual image such as symbology which is generated from one or more sensors in the real world or associated with the situation in which the visor 102 is in use. The term symbology is used to describe all types of augmented or virtual imagery which is associated with the needs of a user wearing the visor. The sensors may include sensors for: visible and non-visible wavelengths; temperature; location; position; velocity; acceleration and any other sensor appropriate to the situation.

The inner coating 206 has a reflectivity R_{D} and a transmission coefficient T_{D}. The outer coating 212 has a reflectivity R_{AR}. The polycarbonate combiner 200 has a transmission coefficient of T_{poly}. The strength of the primary image 207 is proportional to R_{D} (∝R_{D}). The strength of the secondary reflection 214 is proportional to T_{D}² and proportional to T_{poly}² and R_{AR} (∝T_{D}²·T_{poly}²·R_{AR}). Look at the strength of the secondary reflection 214 relative to the primary then:

$$Relative strength of the secondary reflection = {T}_{D}^{2} \cdot {T}_{poly}^{2} \cdot {R}_{A R} / {R}_{D}$$

By maximising transmissivity of light from the real world T_{poly} ˜1 the relative strength of the secondary reflection becomes:

$$Relative strength of the secondary reflection = {T}_{D}^{2} \cdot {R}_{A R} / {R}_{D}$$

Assuming that the inner coating 206 is of reasonable quality, then for any wavelength in the visible (T_{D}+R_{D})˜1 increasing the reflectivity of the inner coating for the source wavelengths will also reduce the transmission coefficient of the inner coating.

An understanding of these observations has led to the following solution to reduce secondary reflections and maximise transmissivity of light from the real world in visors.

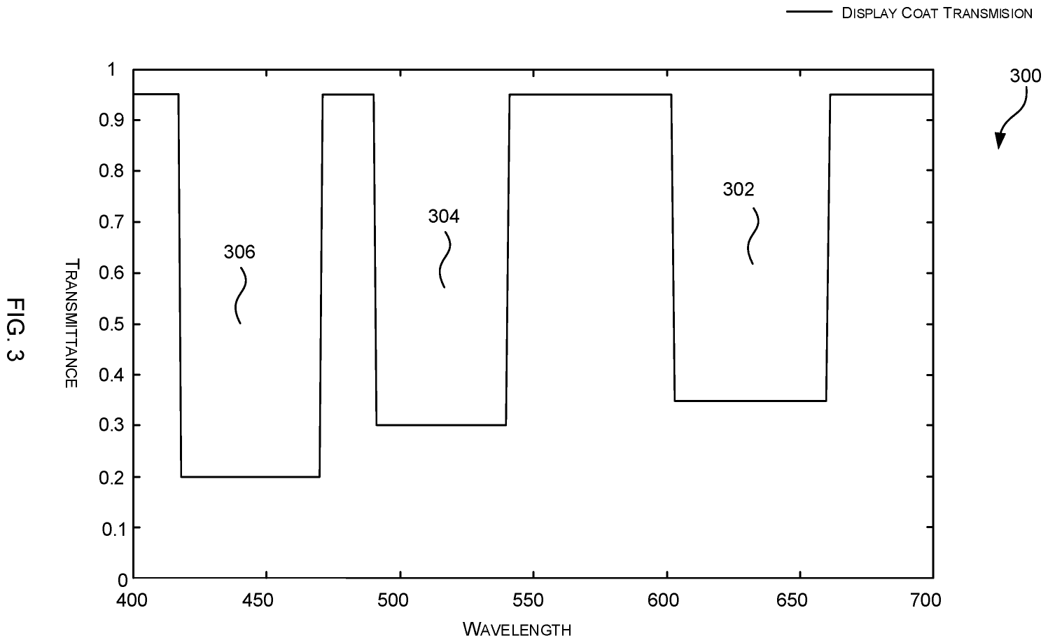

FIG. 3 is a graph 300 showing transmission characteristics of an anti-reflective coating, such as coating 206. The coating has, three notches 302, 304, and 306 centred on respective RGB wavelengths. The coating is applied to an optical surface (not shown) of a visor or any other appropriate optical surface. The reflectivity of the coating is dependent on a number of variables including notch bandwidth; reflectivity of notches and reflectivity between notches. In addition, the notches have further variables such as size, depth, spacing, etc. The figure shows three notches centred at three specific wavelengths. It will be appreciated that there may be a different number of notches being located at different specific locations.

By reflecting the RGB off the inside surface coating 206, the amount of light reaching the outer surface of the combiner is reduced which reduces the amount of light reflected by the anti-reflection coating 212 on the outer surface so reducing the strength of this reflection compared to the primary image off the inside surface. Typical values according to the present invention includes the following possible variables:
Reflectivity of notch for each of RGB
   65% (Red)
   70% (Green)
   80% (Blue)
Reflectivity between notches
   5%
Relative Luminance
   193% baseline (Red)
   175% baseline (Green)
   183% baseline (Blue)
Coating effective index
   n*=2.0

This set of variable used as one example gives the following performance attributes.
Secondary Reflection (0.5% AR)
0.153% (Red), 0.215% (Green), 0.186% (Blue)
Outside World Transmission 66%
P53 Transmission 93%
Outside World Colouration <0.042 units in CIE 1976 colour space (u′, v′).

In use the visor enables the presentation to the user of an virtual images whilst maintaining so some extent their view of the real world; as such it may be referred to as an augmented reality system. The virtual images include symbology as described above and the real world includes images of an external scene and/or details of the user location, for example a cockpit.

These notch characteristics provide a coating that is able to perform advantageously. (Similar characteristics-such as +/−10% reflectivity with +/−5 nm full-width-half-max notches-would also offer advantageous performance).

In particular the characteristics facilitate high reflectivity of the display optics light, which tends to minimise onward transmission of the optics light and hence reduce the brightness of secondary reflections.

Moreover, these characteristics tend to maintain performance: even as the angle of the light varies (e.g. due to spatial variety of the symbology and its placement); even given manufacturing tolerances in the display optics light source and the coating; and even as thermal effects occur (e.g. wavelength shift in the source or coating behaviour with temperature change).

Such notch characteristics tend to provide lower outside world transmission (e.g. 66%), and can tend to tint the outside world view, either of which could be considered disadvantageous in certain situations. However, such a trade-off is surprisingly acceptable in some contexts (e.g. where the visor is for a pilot).

It should be noted that the visor is one element that can be coated as described. The coatings could be applied to other optical devices including a head mounted or worn device (HMD, HWD), a heads up device (HUD) or any other imaging system where the problem of undesirable secondary reflections occur.

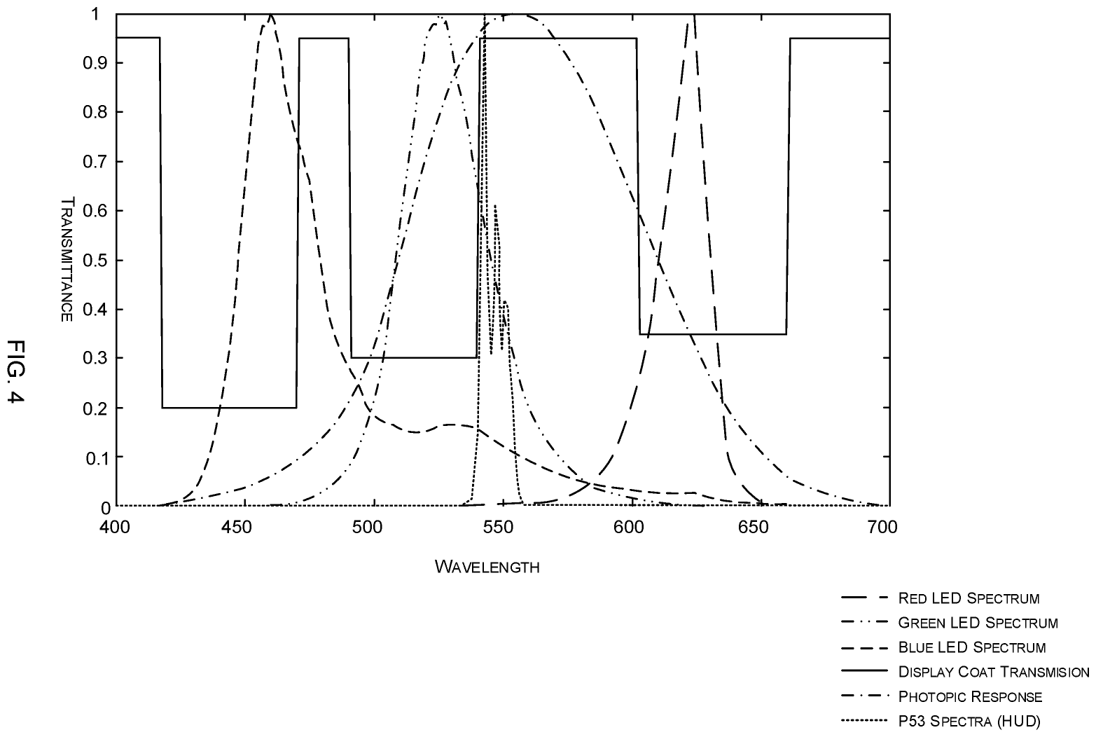

FIG. 4 shows the optical spectrum and filtered spectrum of RGB when impinging on the coating 206 of the present invention. From this and the performance attributes above it is clear to see that the coatings applied to the visor offer low transmittance of red green and blue bands. As such there is minimal opportunity for secondary reflections and the associated artefacts viewable by a user.

Where the visor is for use in on-board piloting of an aircraft, the amount of light entering the visor from the outside world is relatively high (e.g. as compared with ground based vehicles). Accordingly, surprisingly dim visors (i.e. visors with low transmittance) can be acceptable. In addition, the photopic response of the coating ensures a strong transmittance and luminosity when compared to traditional visors.

It will be appreciated that the specific variables and results may not be exactly as indicated but can include many alternatives.

An additional advantage of the visor coating is that the design can be optimised so as to maintain or improve on the outside world contrast of a classic P53 or P43 phosphor based heads up display viewed through the visor. The wavelength of the green LED light source is as shown in FIG. 4. The peak of the green LED spectral output is below the spectra of the P53 head up display also shown in FIG. 4. The green notch reflective part of the combiner coating can be designed so as to maximise the transmission of the P53 spectrum whilst still reflecting the majority of the green LED spectrum. If the typical values for the transmission of P53 spectrum through the visor coating given above (93%) compared to the outside world transmission also given above (66%) then as 93%>66% the P53 HUD symbology contrast against the outside world has been improved when looking through the visor. To further improve this technique, the now unused upper wavelength part of the green LED spectra would ideally be filtered out in the HMD display optics prior to it ever reaching the visor so as to prevent it from contributing to the secondary image.

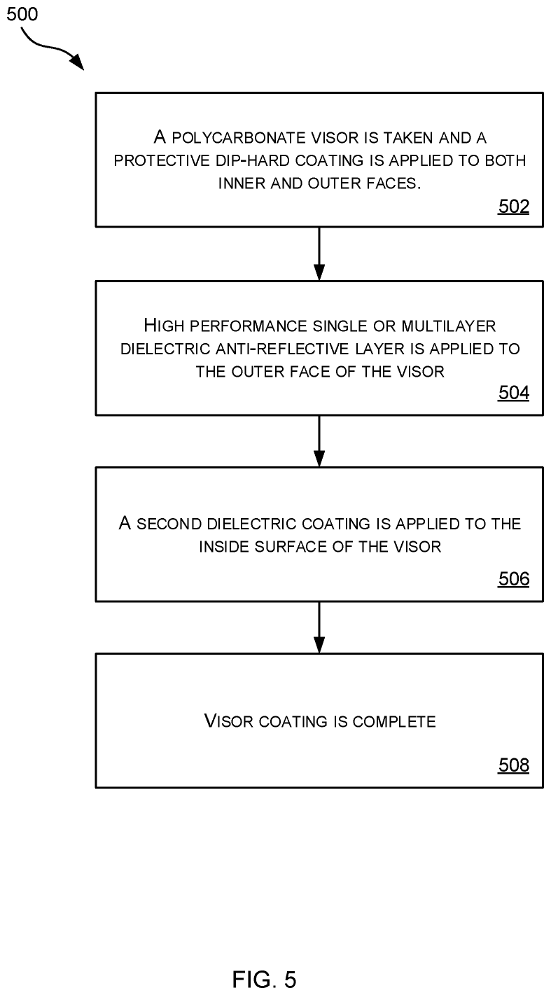

In order to apply the anti-reflective coating of the present invention the process 500 is implemented as described with reference to FIG. 5.

In a first step 502 a hard coated polycarbonate visor is taken and a protective dip-hard coating is applied to both inner and outer faces. This helps protect the visor from scratches and helps provide a better base for the dielectric coatings added on top. A high performance single or multilayer dielectric anti-reflective layer is applied to the outer face of the visor 504. The layers are designed and made using any appropriate process. The anti-reflective coating may be a single layer or a higher performance multilayer coating.

In a second step 504 a dielectric coating is applied to the outside surface of the visor using an appropriate process forming an anti-reflection coating.

In a third step 506 a second coating is designed which consists of several dielectric material layers to be applied to the inner surface of the visor and includes three different notch filters. For an RGB display a first notch is located in the blue wavelength region, a second notch is located in the green wavelength region and a third notch is located in the red wavelength region. The design takes into account the wavelength of the image source, the range of angles over which the coating needs to perform as well as optimising the overall performance considering reflection efficiency and outside world transmission.

It should be noted that the second coating can include one or more notches. A single notch could be used in situations where a single wavelength is required to be viewed (e.g. the display optics operate at only one wavelength) and two notches for two wavelengths. Three notches are shown for RGB but for different wavelengths further notches could be included.

The first notch includes a full-width-half-max of approximately 50 nm, and a peak reflectivity of approximately 80%, the second notch includes a full-width-half-max of approximately 50 nm, and a peak reflectivity of approximately 70%, and the third notch has a full-width-half-max of approximately 50 nm, and a peak reflectivity of approximately 65%. The values above are by way of example. The wavelength of the notch will be dependent on the spectrum of the source and the range of angles of incidence that the coating needs to operate over and the measurement angle, and include a centre of the first notch of approximately 440 nm, a centre of the second notch of approximately 520 nm, and a centre of the third notch of approximately 630 nm, by way of example.

The visor coating is then complete 508.

The present invention relates to a visor, but it will be understood that the coating may be applied to different surfaces such as for example an eyepiece assembly with similar secondary image issues, optical devices including a head mounted or worn device (HMD, HWD), a heads up device (HUD) or any other imaging system where the problem of undesirable secondary reflections occur. The wavelength ranges discussed herein are examples. Other visors or surfaces could be configured for different wavelength regions, in which case the notches would be centred at different wavelengths, from ultra-violet to infra-red.

It should further be noted that the ability to provides different numbers of notches and wavelength ranges will further optimise the transmission of symbology as it can be tuned to different situations. The helmet may have different visors for different situations.

Although the present invention has been described in connection with some aspects, it is not intended to be limited to the specific form set forth herein. Rather, the scope of the present invention is limited only by the accompanying claims. Additionally, although a feature may appear to be described in connection with particular aspects, one skilled in the art would recognize that various features of the described aspects may be combined in accordance with the invention. In the claims, the term ‘comprising’ does not exclude the presence of other elements or steps.

Furthermore, although individually listed, a plurality of means, elements or method steps may be implemented by, for example, a single unit or step. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

1. A coating for an optical surface for reducing secondary reflections from narrow wavelength band image sources, the coating comprising multiple notch filters located at different predetermined wavelength regions.

2. The coating according to claim 1, wherein the multiple notch filters comprise three notch filters.

3. The coating according to claim 1, wherein the different predetermined wavelength regions comprise red, green, and blue wavelength regions.

4. The coating according to claim 1, wherein a first notch includes a full-width-half-max of about 50 nm, and a peak reflectivity of about 80%.

5. The coating according to claim 4, wherein a second notch includes a full-width-half-max of about 50 nm, and a peak reflectivity of about 70%.

6. The coating according to claim 5, wherein a third notch has a full-width-half-max of about 50 nm, and a peak reflectivity of about 65%.

7. The coating according to claim 1, wherein a centre of a first notch is approximately 440 nm; a centre of a second notch is approximately 520 nm, and a centre of a third notch is approximately 630 nm.

8. The coating according to claim 1, wherein the coating further comprises a first dielectric coating under the multiple notch filters and/or a second dielectric coating over the multiple notch filters.

9. A visor having the coating according to claim 1.

10. The visor according to claim 9, wherein the visor is made from a polycarbonate material

11. The visor according to claim 9, wherein the coating is located on an inner surface of the visor.

12. The visor according to claim 9, including a further anti-reflective coating located on an outer surface of the visor.

13. A helmet including the visor according to claim 9.

14. A method of applying a coating, that reduces secondary reflection from narrow wavelength band images sources to an optical surface, the method comprising: applying multiple layers of material each having a notch filter located at different predetermined wavelength regions.

15. The method according to claim 14, wherein the method comprises applying three layers of material to form respective notches in the red, green, and blue wavelength regions.

16. The method according to claim 14, wherein the coating is applied to a polycarbonate visor.

17. A coating for an optical surface for reducing secondary reflections from narrow wavelength band image sources, the coating comprising multiple notch filters located at different predetermined wavelength regions, wherein:
the multiple notch filters including a first notch filter, a second notch filter, and a third notch filter;
the first notch filter located at a blue wavelength region, and having a full-width-half-max in the range of 45 to 55 nm and a peak reflectivity in the range of 75 to 85%;
the second notch filter located at a green wavelength region, and having a full-width-half-max in the range of 45 to 55 nm and a peak reflectivity in the range of 65 to 75%; and
the third notch filter located at a red wavelength region, and having a full-width-half-max in the range of 45 to 55 nm and a peak reflectivity in the range of 60 to 70%.

18. The coating according to claim 17, wherein the coating further comprises a first dielectric coating under the multiple notch filters and/or a second dielectric coating over the multiple notch filters.

19. A visor having the coating according to claim 17.

20. The visor according to claim 19, wherein the visor is made from a polycarbonate material, and the coating is located on an inner surface of the visor, the visor including a further anti-reflective coating located on an outer surface of the visor.
